(19) United States
(12) Patent Application Publication
(10) Pub. No.: US 2026/0356691 A1
(43) Pub. Date: Nov. 12, 2026

(54) PROCESS FOR THE PREPARATION OF NICKEL OXIDE

(71) Applicant: BASF SE, Ludwigshafen Am Rhein (DE)

(72) Inventors: Maximilian DOMASCHKE, Ludwigshafen am Rhein (DE); Ralf BOEHLING, Ludwigshafen am Rhein (DE); Sebastian WOLFER, Ludwigshafen am Rhein (DE); Gerardo INCERA GARRIDO, Shanghai (CN); Felix EBERLE, Ludwigshafen am Rhein (DE); Kai Rainer EHRHARDT, Ludwigshafen am Rhein (DE)

(21) Appl. No.: 18/997,531

(22) PCT Filed: Aug. 17, 2023
(86) PCT No.: PCT/EP2023/072733

§ 371 Date: Jan. 22, 2025

(30) Foreign Application Priority Data
Aug. 23, 2022 (EP) 22191670.3
Mar. 14, 2023 (EP) 23161751.5

(51) Int. Cl. C01G 53/04; H01M 4/02; H01M 4/525

(52) U.S. Cl. CPC C01G 53/04; H01M 4/525; C01P 2006/40; H01M 2004/028

(57) ABSTRACT

Disclosed herein is a process for the preparation of NiO particles including the step of a₀) contacting a Ni(CO)₄ gas stream having a temperature of less than 100 °C with an oxidizing gas stream to directly yield NiO particles in the product stream of a reactor.

The present invention relates to a process for the preparation of NiO particles.

Nickel oxide (NiO) particles are useful for many technical applications, including as cathode active material (CAM).

The classical manufacturing route for cathode active material (CAM) proceeds via the precipitation of the sulphates of Ni, Co and Mn with NaOH as mixed metal hydroxides. During this precipitation, a large amount of Na₂SO₄ is generated (more than 1 kg per kg of final CAM). To convert the mixed metal hydroxides to oxide material water has to be removed in an energy-intense pre-calcination step. Furthermore, metal sulphates are costly starting materials since they are produced at a late step in the base metal refinery value chain.

Alternatively, the preparation of nickel oxide nanoparticles starts with Ni metal. A source for relatively pure nickel metal is the decomposition of nickel tetracarbonyl (Handbook of non-ferrous metal powders, Elsevier Ltd. 2009, chapter 17). However, this multistep approach causes further costs.

Thus, there is a need for an improved preparation process that avoids the above-mentioned disadvantages and is cost effective, has a good environmental balance, avoids high salt loads and can result in pure CAM.

Accordingly, an object of the present invention is to provide such a process for the preparation of nickel oxide.

The object is achieved by a process for the preparation of NiO particles comprising the step of
a₀) contacting a Ni(CO)₄ gas stream having a temperature of less than 100 °C with an oxidizing gas stream to directly yield NiO particles in a product stream of a reactor.

The inventors have found that it is possible to directly obtain nickel oxide from nickel carbonyl without the intermediate step of the decomposition of Ni carbonyl to Ni metal resulting in the above characteristics of the process. Especially, the main economical potential arises from the facts that appropriate Ni sources can be accessed early in the metal value chain and that fewer process steps may be required to produce CAM. Furthermore, the costly treatment of salt, especially sodium sulphate, byproduct can be avoided. The process of the present invention can be applied to produce material that can be further converted to CAM. It is possible to produce material of especially high purity.

The process of the present invention comprises the step of contacting a Ni(CO)₄ gas stream having a temperature of less than 100 °C with an oxidizing gas stream to directly yield NiO particles in a product stream of a reactor.

In order to prepare a Ni(CO)₄ gas stream, metallic Ni can be treated with carbon monoxide at elevated pressure (e.g. above 1 bar) and elevated temperatures (e.g. 30-200 °C) which leads to the formation of Ni(CO)₄ according to the following reaction equation:

Ni+4CO→Ni(CO)₄

Accordingly, in a preferred embodiment the process of the present invention comprises a step of
a₋₁) treating metallic Ni with carbon monoxide at elevated pressure and elevated temperature to yield the Ni(CO)₄ gas stream optionally containing unreacted carbon monoxide.

The reaction step a₋₁) can be carried out in a first reactor wherein step a₀) can be carried out in a second reactor.

Preferably, the elevated pressure is above atmospheric pressure and below 30 MPa. More preferably, the elevated pressure is between 0.5 MPa and 20 MPa.

Preferably, the elevated temperature is in the range from 30 °C to 200 °C. More preferably, the temperature is in the range from 50 °C to 180 °C.

Unreacted CO may be recycled be separation from the product stream. Also, certain other metals that are part of some feed materials such as Fe and Co may be carbonylated, leading to an impure product. In this case, distillation can be performed to purify the nickel tetracarbonyl. Especially the hydrocarbonyl of cobalt—CoH(CO)₄—can be a valuable side product that can be used analogously to Ni(CO)₄. It forms in the presence of both carbon monoxide and hydrogen. Accordingly, in a preferred embodiment unreacted carbon monoxide is separated off and the separated carbon monoxide is optionally used in step a₋₁).

Preferably, the Ni(CO)₄ gas stream is purified before used in step a₀), more preferably by distillation.

In a preferred embodiment the process of the present invention starts from appropriate Ni feeds, like Ni metal, Ni Matte, Mixed Hydroxide Precipitate (MHP), NiS containing mixed sulfide precipitate, or Black Mass, which can undergo pretreatment in a hydrogen atmosphere to reduce the Ni to its metallic state in case the starting material is not already Ni metal.

Accordingly, in a preferred embodiment of the present invention the process of the present invention comprises a step
a₋₂) reducing Ni matte, Ni(OH)₂ containing mixed hydroxide precipitates, NiS containing mixed sulfide precipitate, NiO containing black mass or a mixture thereof in a hydrogen stream to yield metallic Ni.

Especially Ni Matte, MHP and black mass offer attractive feed materials since they are either extracted at an early point in the Ni value chain (Ni Matte and MHP) or come from a recycling process of batteries and accumulators (black mass).

The optional purified stream is inserted into a reactor where it is brought into contact, e.g. by mixing, with a preferably preheated oxidizing gas such as air or oxygen, preferably at a high level of turbulence. This will result in the decomposition of nickel tetracarbonyl to nickel oxide, which will be finely disperse due to the high supersaturations that can be achieved as a result of the high reaction rates and low vapor pressure of NiO, and carbon monoxide or carbon dioxide, respectively.

The reaction is highly exothermal so that the reaction temperature is high enough to directly oxidize Ni tetracarbonyl to NIO without prior decomposition of Ni tetracarbonyl to metallic Ni. In order to prevent said decomposition, the Ni tetracarbonyl gas stream has a temperature of below 100 °C, preferably from 30 °C to 90 °C, more preferably, in the range from 40 °C to 80 °C, even more preferably, in the range from 45 °C to 70 °C, even more preferably, in the range from 50 °C to 60 °C.

Preferably, the oxidizing gas stream is preheated, which is another option for reaction temperature adjustment.

Accordingly, in a preferred embodiment the oxidizing gas stream in step a₀) is preheated. Preferably, the temperature is in the range from 50 °C to 750 °C. More preferably, the temperature is between 150 and 500 °C.

Preferably, the oxidizing gas is oxygen or an oxygen containing gas, like air or a mixture of air and oxygen.

Preferably, step a₀) can be performed either in an injector where the high flow velocities allow for a flameless oxidation or in a two-component nozzle where a spray flame could be established. In both cases, an adiabatic tube reactor is attached to the mixing point, allowing for a certain residence time at high temperatures to ensure full conversion of the nickel tetracarbonyl and to allow for the development of a defined nickel oxide particle morphology.

The reactor off gas containing the nickel oxide particles can be consecutively cooled by mixing with cold air and heat exchangers before entering an appropriate filter unit for product separation such as a baghouse filter or an electrostatic precipitator. The obtained nickel oxide nanoparticles can be further processed to CAM materials by mixing with metal oxides of cobalt and manganese and consecutive thermal or mechanical treatment.

Accordingly, in a preferred embodiment step a₀) is carried out in an injector where preferably high flow velocities allow for a flameless oxidation. Preferred velocities will depend on the temperature of the oxidizing gas and its mass ratio with the Ni(CO)₄. A preferred requirement will be a Reynolds number in the turbulent regime (thus, Re>4000) in the injector.

In a further preferred embodiment step a₀) is carried out in a two-component nozzle where a spray flame can be established.

Preferably, the reactor in step a₀) is at least partly an adiabatic tube reactor, more preferably an adiabatic reactor.

Preferably, the product stream is cooled, preferably with air having a lower temperature compared to the temperature of the product stream and one or more heat exchangers. A suitable temperature of the product stream after cooling is below 250 °C. The heat exchangers can be coupled with the oxidizing gas stream in order to transfer heat and to generate a preheated oxidizing gas stream for step a₀).

Preferably, the NiO particles are separated off from the product stream, preferably in a filter unit for product separation such as a baghouse filter or an electrostatic precipitator to yield the NiO particles.

As mentioned above, the NiO particles are preferably further processed to cathode active material by mixing with other metal oxides, like cobalt and/or manganese and consecutive thermal and/or mechanical treatment. The NiO particles obtained by the present process typically show a particle size of less than 1 μm, i.e. nanoparticles as can be shown by electron microscopy.

Preferably, step a₀) is carried out at a temperature in the range from 150 °C to 1200 °C. More preferably, step a₀) is carried out at a temperature in the range from 200 °C to 1000 °C.

The Ni(CO)₄ gas stream in step a₀) can further contain carbon monoxide. It is preferred that in case the product stream comprises carbon monoxide, said CO is separated and fed back into step a₋₁).

The resulting NiO product is suitable to be used in the preparation of Cathode Active Material (CAM). CAM is the active composition of a cathode. The preparation of CAM is well known and described e.g. in WO 2021/156124A1 , WO 2022/101103 A1 and WO 2022/263226A1.

Accordingly, another aspect of the present invention is a process for the preparation of a NiO particles containing cathode active material comprising the steps of
b₁) preparing NiO particles according to the process for the preparation of NiO particles of the present invention;
b₂) mixing the NiO particles with one or more other metal oxides and optionally with one or more other components of the cathode active material; and
b₃) calcining the mixture of step b₂) in order to obtain the cathode active material.

Typical metal oxides for mixing with NiO particles are Cobalt oxides, nickel oxides or both, Co oxides and Ni oxides, preferably both Co oxides and Ni oxides. Other components of the CAM that can be added are e.g. a Lithium source, a Natrium source or both, a Li source and a Na source.

A typical Li source is LiOH, L₂CO₃, Li₂O, Li₂O₂ or mixtures thereof. A typical Na source is NaOH, Na₂CO₃, Na₂O, Na₂O₂ or mixtures thereof.

The calcination temperature to be used in step b₃) depends on the specific CAM and typically ranges from 600 °C to 1200 °C, preferably from 800 °C to 1000 °C.

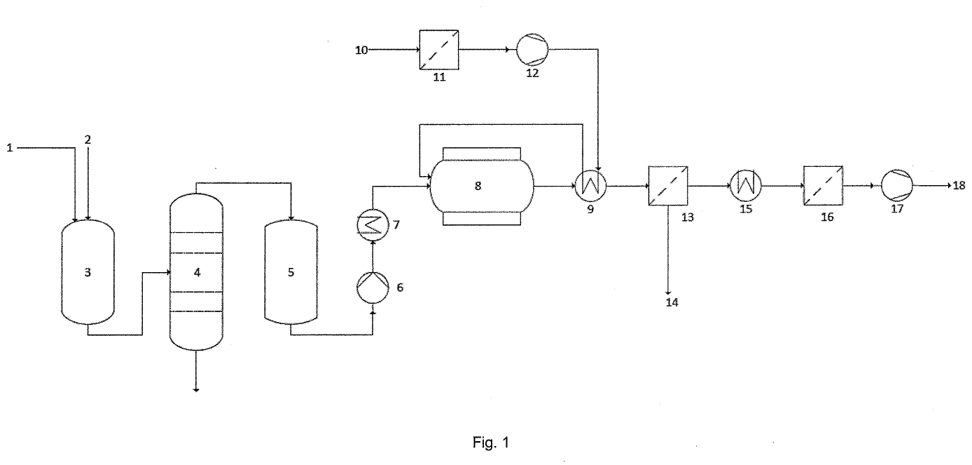

FIG. 1 shows a preferred process of the present invention starting with step a₋₁).

In FIG. 1 a metallic Ni feed (1) that may be obtained by a reductive pretreatment (step a₋₂), not shown) is introduced together with carbon monoxide feed (2) in a carbonylation reactor (3) and the resulting product is transferred into a distillation column (4). The Ni tetracarbonyl feed is transferred to a storage tank (5). The liquid Ni tetracarbonyl is pumped by liquid pump (6) to the pyrolysis reactor (8) via evaporator (7), where an air feed (10) is added to reactor (8) after passing a prefilter (11), compressor (12) and heat exchanger (9). The product stream in reactor (8) is filtered in filter (13) (e.g. Baghouse or electrostatic precipitator) to separate the NiO particles (14) via heat exchanger (9) from the exhaust gas (18) that passes a further heat exchanger (15), HEPA filter (16) and vacuum pump (17).

### EXAMPLES

In one example of the process, Ni powder was pretreated for 6 hours at a temperature of 280 °C with hydrogen to remove any NiO passivation layer. Consecutively, the Ni powder was treated with carbon monoxide at a temperature of 100 °C and a pressure of 0.1 MPa. The mixture of carbon monoxide and Ni(CO)₄ that resulted from this treatment was transferred to the oxidation reactor and contacted with a stream of air preheated to 200 °C and having an average flow velocity of about 340 m/s. The NiO nanoparticles that formed in the oxidation of the Ni(CO)₄ were collected by thermophoresis for analysis.

### REFERENCE MARK LIST

1 . . . Ni feed
2 . . . Carbon monoxide
3 . . . Carbonylation reactor
4 . . . Distillation column
5 . . . Storage tank
6 . . . Liquid pump
7 . . . Evaporator
8 . . . Pyrolysis reactor
9 . . . Heat exchanger
10 . . . Air
11 . . . Prefilter
12 . . . Compressor
13 . . . Filter
14 . . . NiO particles
15 . . . Heat exchanger
16 . . . HEPA-Filter
17 . . . Vacuum pump
18 . . . Exhaust gas

1. A process for the preparation of NiO particles comprising the step of
a₀) contacting a Ni(CO)₄ gas stream having a temperature of less than 100 °C with an oxidizing gas stream to directly yield NiO particles in a product stream of a reactor.

2. The process of according to claim 1, wherein the Ni(CO)₄ gas stream is prepared by a step preceding step a₀), wherein the step is
a₋₁) treating metallic Ni with carbon monoxide at elevated pressure and elevated temperature to yield the Ni(CO)₄ gas stream optionally containing unreacted carbon monoxide, wherein the elevated pressure is above atmospheric pressure and below 30 MPa and wherein the elevated temperature is in the range from 30 C to 200 C and wherein the metallic Ni is optionally prepared by a step preceding step a₋₁), where the step is
a₋₂) reducing Ni matte, Ni(OH)₂ containing mixed hydroxide precipitates, NiS containing mixed sulfide precipitate, NiO containing black mass or a mixture thereof in a hydrogen stream to yield metallic Ni.

3. The process according to claim 1, wherein unreacted carbon monoxide is separated off and the separated carbon monoxide is optionally used in step a₋₁).

4. The process according to claim 1, wherein the Ni(CO)₄ gas stream is purified, before being used in step a₀).

5. The process according to claim 1, wherein the oxidizing gas in step a₀) is preheated.

6. The process according to claim 1, wherein the oxidizing gas is oxygen or an oxygen containing gas.

7. The process according to claim 1,
wherein the contacting in step a₀) comprises a mixing step; and/or
wherein step a₀) is carried out in an injector where flow velocities allow for a flameless oxidation or in a two-component nozzle where a spray flame can be established; and/or
wherein the reactor in step a₀) is at least partly an adiabatic tube reactor; and/or
wherein contacting in step a₀) is carried out at a temperature in the range from 150 °C to 1200 °C; and/or
wherein the Ni(CO)₄ gas stream in step a₀) further contains carbon monoxide; and/or
wherein in step a₀) the Ni(CO)₄ gas stream has a temperature in the range from 30 C to 90 °C.

8. The process according to claim 1, wherein the product stream is cooled.

9. The process according to claim 1, wherein the NiO particles are separated off from the product stream.

10. The process according to claim 1, wherein the NiO particles are further processed to cathode active material by mixing with other metal oxides, and consecutive thermal and/or mechanical treatment.

11. The process according to claim 1, wherein the product stream comprises carbon monoxide, which is separated and fed back into step a₋₁).

12. A process for the preparation of a NiO particles containing cathode active material comprising the steps of
b₁) preparing NiO particles according to the process for the preparation of NiO particles of claim 1;
b₂) mixing the NiO particles with one or more other metal oxides and optionally with one or more other components of the cathode active material; and
b₃) calcining the mixture of step b₂) in order to obtain the cathode active material.

13. The process according to claim 12, wherein the one or more other metal oxides are cobalt oxides, nickel oxides or both, Co oxides and Ni oxides.

14. The process according to claim 12, wherein in step b₂) NiO particles are mixed with one or more other metal oxides and with one or more other components of the cathode active material.

15. The process according to claim 12, wherein in step b₂) NiO particles are mixed with one or more other metal oxides and with one or more other components of the cathode active material.

16-29. (canceled)

30. The process according to claim 1, wherein the Ni(CO)₄ gas stream is purified by distillation before being used in step a₀).

31. The process according to claim 1, wherein the oxidizing gas in step a₀) is preheated to a temperature in the range from 50 C to 750 °C.

32. The process according to claim 1, wherein in step a₀) the Ni(CO)₄ gas stream has a temperature in the range from 40 C to 80 C.

33. The process according to claim 1, wherein the product stream is cooled with air having a lower temperature compared to the temperature of the product stream and one or more heat exchangers.

34. The process according to claim 1, wherein the NiO particles are separated off from the product stream in a filter unit for product separation such as a baghouse filter or an electrostatic precipitator to yield the NiO particles.
